(19) United States
(12) Patent Application Publication
(10) Pub. No.: US 2023/0381850 A1
(43) Pub. Date: Nov. 30, 2023

(54) USE OF A MACHINE TOOL

(71) Applicant: Schaeffler Technologies AG & Co. KG, Herzogenaurach (DE)

(72) Inventors: Bernhard Sanders, Roßtal (DE); Stefan Conrad, Brasov (RO)

(73) Assignee: Schaeffler Technologies AG & Co. KG, Herzogenaurach (DE)

(21) Appl. No.: 18/034,151

(22) PCT Filed: Nov. 3, 2021
(86) PCT No.: PCT/DE2021/100870

§ 371 Date: Apr. 27, 2023

(30) Foreign Application Priority Data
Nov. 10, 2020 (DE) 10 2020 129 631.2
Nov. 2, 2021 (DE) 10 2021 128 438.4

(51) Int. Cl. B21D 53/12; F16C 33/46

(52) U.S. Cl. CPC B21D 53/12; F16C 33/4629; F16C 2220/62

(57) ABSTRACT

A device for machining rolling element pockets in a workpiece includes a workpiece support, a main spindle, a clamping means fastened to the main spindle, a pressure cylinder and a machining tool. The clamping means includes a receiving arrangement for fastening the clamping means to the main spindle and a pressure plate for pressing the workpiece on the workpiece support. The pressure plate has a passage opening. The pressure cylinder connects the receiving arrangement to the pressure plate. The pressure cylinder is arranged to provide a force to adjust a contact pressure of the pressure plate on the workpiece. The machining tool is fastened to the main spindle and guidable through the passage opening to machine the workpiece.

### CROSS-REFERENCE TO RELATED APPLICATIONS

This application is the United States National Phase of PCT Appln. No. PCT/DE2021/100870 filed Nov. 3, 2021, which claims priority to German Application Nos. DE102020129631.2 filed Nov. 10, 2020 and DE102021128438.4 filed Nov. 2, 2021, the entire disclosures of which are incorporated by reference herein.

### TECHNICAL FIELD

The present disclosure relates to the use of a machine tool.

### BACKGROUND

A machining tool in the form of a hard metal drill is often used in the production of pockets 8 for forming a rolling bearing cage 9 (ref FIG. 1). The hard metal drill machines the material in the resulting cage pocket 8 in an axial direction with appropriate cutting speeds and advancing motions. It is necessary to keep the resulting cage 9 in its predetermined position in the process. In the past, the predetermined position of the cage 9 was secured by placing and manually tightening a clamping cover 5 on the workpiece (ref FIG. 1). This clamping cover 5 was provided with openings 6 which allowed the machining tool to pass through to the workpiece.

The design of the clamping cover 5 and the openings 6 must be matched to the pitch circle of the bore and the diameter of the pockets 8. Since many of the dimensions of various cages are not identical, it was necessary to structurally design and produce a large number of clamping covers 5. This is costly in terms of design, manufacturing and storage costs.

Optimal cooling of the tool cutting edges is also difficult. Chip build-up forms and there is a risk of chips being drawn into the pocket bore. Each clamping cover must be clamped manually with the appropriate torque. The time required to attach and detach the cover for each workpiece to be machined is appreciable.

DE 10 2017 118 738 A1 discloses a method for producing a comb-shaped cage using a milling tool, with a drill jig applying a mechanical or hydraulic holding force to the workpiece.

DE 10 2006 004 932 A1 discloses a hold-down device for a machine tool.

AT 509 502 B1 discloses a device for machining a workpiece having a composite material with fibers and a matrix material. A tool, in particular a drilling or milling tool, is rotatably mounted in a stator or a spindle. Furthermore, a hold-down element is provided, which is pressed against the surface of the workpiece and is intended to prevent fraying or damage to the workpiece in the region adjacent to the machining point.

### SUMMARY

According to the present disclosure, the use of a machine tool for introducing and/or machining pockets for receiving rolling elements on a workpiece in the form of a rolling bearing cage is provided. The machine tool includes a workpiece support and a main spindle, and a machining tool and a clamping means are fastened to the main spindle. The clamping means includes a receiving arrangement for fastening the clamping means to the main spindle of the machine tool and a pressure plate for pressing a workpiece on a workpiece support. The receiving arrangement and the pressure plate are connected via at least one pressure cylinder. A contact pressure of the pressure plate on the workpiece can be adjusted in a defined manner by means of the at least one pressure cylinder. The machining tool is arranged in such a way that the machining tool can be guided through a passage opening in the pressure plate when machining the workpiece pressed against the workpiece support by means of the pressure plate.

The machining tool and the clamping means may be fastened to the main spindle via a standard interface, for example of the steep taper interface type, high shank taper interface type or Capto type.

The rolling bearing cage is, for example, formed from copper or a copper-based alloy. Such rolling bearing cages are prone to warping and torsion during machining, especially during the manufacture of pockets for receiving rolling elements.

The pressure plate is, for example, annular and forms a passage opening for a machining tool fastened to the spindle.

The machining tool may be arranged in such a way that the machining tool can be guided centrally through the passage opening in the pressure plate during machining of the workpiece pressed against the workpiece support by means of the pressure plate.

The machining tool may be formed by a drilling device or by a milling device.

The use may include a method for producing at least one pocket for receiving a rolling element on a workpiece in the form of a rolling bearing cage with the following steps:
providing the machine tool,
fixing a position of the rolling bearing cage on the workpiece support,
pressing the rolling bearing cage against the workpiece support using the pressure plate,
forming a first pocket using the machining tool, and
detaching the pressure plate from the rolling bearing cage.

The at least one pocket may be drilled or milled.

In comparison with the prior art, the pressure plate of the clamping means replaces a clamping cover, and at least one pressure cylinder, e.g., two or three pressure cylinders, holds the side walls of the pocket in position. These pressure cylinders release and clamp the side walls of the pocket with a stroke movement. In an example embodiment, the pressure cylinders are hydraulic cylinders. In an example embodiment, a spring force of the pressure cylinders can be adjusted via valves.

The contact pressure or clamping pressure can be adjusted in a targeted and defined manner so that it can be kept constant throughout the entire machining step.

In addition, the clamping means, following the movement axes of the main spindle, can be arranged not only to press perpendicular to the rolling bearing component, but can also be pressed at an angle to the vertical. Therefore, if the rolling bearing cage has an inclined surface on its upper side facing away from the workpiece support, the pressure plate can be placed on it and pressed against it.

The use according to the disclosure involves cost savings with respect to the design, production and storage costs of the previously used clamping covers.

Just one clamping means can be used for all cage types to be machined.

In addition, precise clamping is possible. The clamping means may enable improved cooling of the tool cutting edge of the machining tool. Lubricant can be supplied to the machining tool in a simple manner.

For this purpose, at least one lubricant supply device may be provided on the clamping means.

The formation of chip build-up is reliably avoided. The use of the clamping means may lead to minimization in set-up times during the machining of cage pockets. The use of the clamping means prevents warping of the rolling bearing cage during machining, increases machining accuracy and thus also accuracy of the final component geometry.

### BRIEF DESCRIPTION OF THE DRAWINGS

FIGS. 1 to 3 are intended to explain the disclosure by way of example. In the figures:

FIG. 1 shows a clamping cover according to a conventional manufacturing method according to the prior art;

FIG. 2 shows a clamping means in a machine tool, and

FIG. 3 shows a clamping means together with a clamping plate in a machine tool.

### DETAILED DESCRIPTION

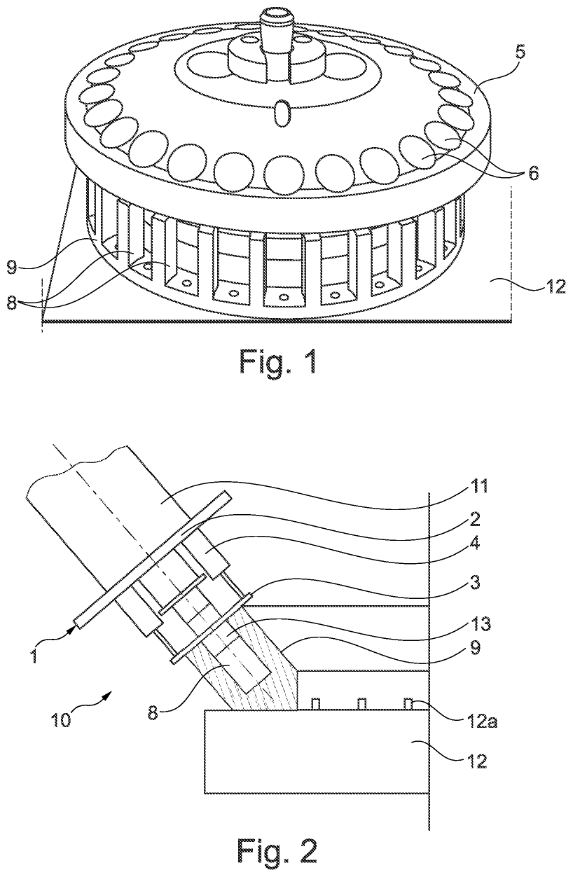

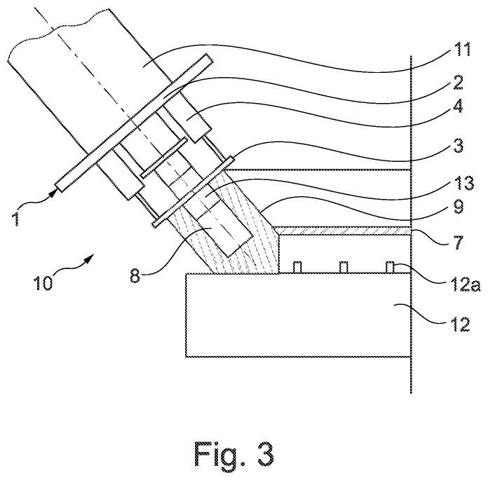

FIG. 1 has already been explained in the BACKGROUND and shows a conventional manufacturing method according to the prior art using a clamping cover 5 with openings 6, which clamps a workpiece 9 in the form of a rolling bearing cage with pockets 8 against a workpiece support 12. A machining tool in the form of a drill, not shown here, is guided through the openings 6 in the clamping cover 5 in order to form the pockets 8.

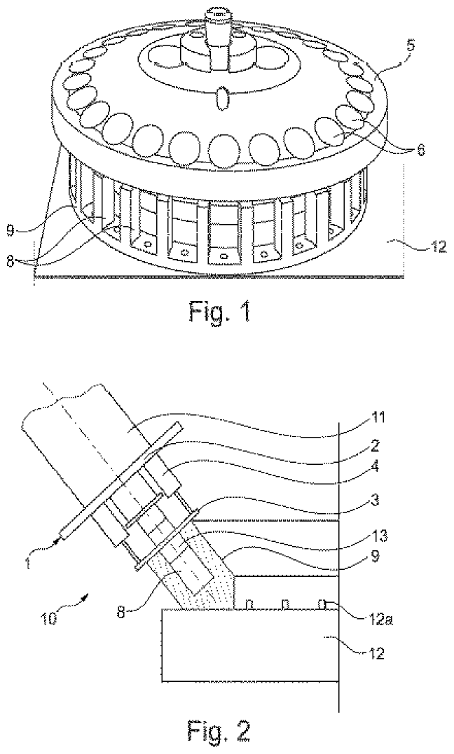

FIG. 2 shows a clamping means 1 in a machine tool 10. The clamping means 1 includes a receiving arrangement 2 for fastening the clamping means 1 to a spindle 11, here the main spindle, of the machine tool 10. The clamping means 1 also includes a pressure plate 3 for pressing a workpiece 9 in the form of an inclined cage on a workpiece support 12 of the machine tool 10. The inclined cage is shown in sectional view and in half section. The position of the inclined cage is fixed on the workpiece support 12 in the region of its inner diameter by fixing clamps 12a.

The receiving arrangement 2 and the pressure plate 3 are connected via two pressure cylinders 4 in the present case. By means of the pressure cylinder 4, a contact pressure of the pressure plate 3 on the workpiece 9, in the present case the inclined cage, can be adjusted in a defined manner. The machine tool 10 includes a machining tool 13 in the form of a drilling tool. This plunges through the pressure plate 3 and forms the pocket 8 in the workpiece 9. The spindle 11 is oriented here at a 45° angle to the workpiece support 12 in order to form the pocket 8 in the inclined cage. However, the spindle 11 can also be oriented at a different angle to the workpiece support 12, depending on the type of cage to be machined. The machining of straight cages, as shown in FIG. 1, is carried out by orienting the spindle 11 at a 90° angle to the workpiece support 12.

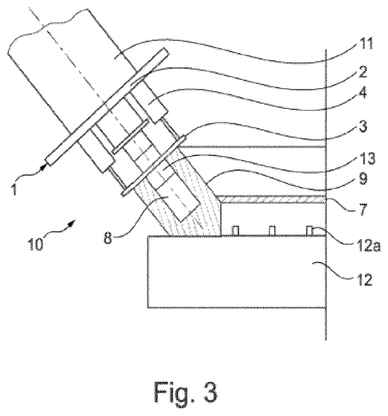

FIG. 3 shows a clamping means 1 together with a clamping plate 7 in a machine tool 10. The same reference signs as in FIG. 2 indicate identical elements. The clamping plate 7 additionally arranged here enables a central fixation of the position of the rolling bearing cage, for example via a central screw connection (not shown here) of the clamping plate 7 on the workpiece support 12, so the fixing clamps 12a can optionally be omitted.

### REFERENCE NUMERALS

1 Clamping means
2 Receiving arrangement
3 Pressure plate
4 Pressure cylinder
5 Clamping cover
6 Opening in the clamping cover
7 Clamping plate
8 Pocket
9 Workpiece
10 Machine tool
11 Spindle, main spindle
12 Workpiece support
12a Fixing clamp
13 Machining tool

1. A use of a machine tool for machining pockets for receiving rolling elements on a workpiece in the form of a rolling bearing cage, wherein the machine tool is designed to comprise a workpiece support and a main spindle, wherein a machining tool and a clamping means are fastened to the main spindle, wherein the clamping means is designed to comprise a receiving arrangement for fastening the clamping means to the main spindle of the machine tool and a pressure plate for pressing a workpiece on a workpiece support, wherein the receiving arrangement and the pressure plate are connected via at least one pressure cylinder, wherein a contact pressure of the pressure plate on the workpiece can be adjusted in a defined manner by means of the at least one pressure cylinder, and wherein the machining tool is arranged in such a way that the machining tool can be guided through a passage opening in the pressure plate during the machining of the workpiece pressed against the workpiece support by means of the pressure plate.

2. The use according to claim 1, wherein the pressure plate is annular and forms the passage opening for the machining tool fastened to the spindle.

3. The use according to claim 1, wherein the machining tool is arranged in such a way that the machining tool can be guided centrally through the passage opening in the pressure plate when machining the workpiece pressed against the workpiece support by means of the pressure plate.

4. The use according to claim 1, wherein the machining tool is formed by a drilling device.

5. The use according to claim 1, wherein the machining tool is formed by a milling device.

6. The use according to claim 1, wherein the production of at least one pocket for receiving a rolling element on a workpiece in the form of a rolling bearing cage comprises the following steps:
providing the machine tool,
fixing a position of the rolling bearing cage on the workpiece support,
pressing the rolling bearing cage against the workpiece support using the pressure plate,
forming a first pocket using the machining tool, and
detaching the pressure plate from the rolling bearing cage.

7. The use according to claim 6, wherein the at least one pocket is drilled or milled.

8. The use according to claim 1, wherein the rolling bearing cage is formed from copper or a copper-based alloy.

9. The use according to claim 1, wherein a spring force of the at least one pressure cylinder can be adjusted via valves.

10. The use according to claim 1, wherein at least one lubricant supply device is provided on the clamping means.

11. A device for machining rolling element pockets in a workpiece, comprising:
a workpiece support;
a main spindle;
a clamping means fastened to the main spindle, the clamping means comprising:
a receiving arrangement for fastening the clamping means to the main spindle; and
a pressure plate for pressing the workpiece on the workpiece support, the pressure plate comprising a passage opening; and
a pressure cylinder connecting the receiving arrangement to the pressure plate, the pressure cylinder being arranged to provide a force to adjust a contact pressure of the pressure plate on the workpiece; and
a machining tool fastened to the main spindle and guidable through the passage opening to machine the workpiece.

12. The device of claim 11, wherein the pressure plate is annular.

13. The device of claim 11, wherein the machining tool is arranged to be guided centrally through the passage opening.

14. The device of claim 11, wherein the machining tool is a drilling device or a milling device.

15. The device of claim 11, further comprising a valve for adjusting the force provided by the pressure cylinder.

16. The device of claim 11, further comprising a lubricant supply device disposed on the clamping means.

17. A method for producing a pocket for a rolling element on a rolling bearing cage, comprising:
providing the device of claim 11;
fixing the rolling bearing cage on the workpiece support;
pressing the rolling bearing cage against the workpiece support using the pressure plate;
forming the pocket using the machining tool; and
releasing the pressure plate from the rolling bearing cage.

18. The method of claim 17, wherein the pocket is drilled or milled using the machining tool.

19. The method of claim 17, wherein the rolling bearing cage is formed from copper or a copper-based alloy.
